(19) United States
(12) Patent Application Publication
(10) Pub. No.: US 2023/0400900 A1
(43) Pub. Date: Dec. 14, 2023

(54) MANAGING THERMAL AND ACOUSTIC CHARACTERISTICS OF AN INFORMATION HANDLING SYSTEM (IHS) BASED ON THE USE OF EXTERNAL PERIPHERAL DEVICES

(71) Applicant: Dell Products, L.P., Round Rock, TX (US)

(72) Inventors: Suraj M. Varma, Portland, OR (US); Daniel L. Hamlin, Round Rock, TX (US); Travis C. North, Cedar Park, TX (US)

(73) Assignee: Dell Products, L.P., Round Rock, TX (US)

(21) Appl. No.: 17/806,904

(22) Filed: Jun. 14, 2022

(51) Int. Cl. G06F 1/20; G06F 1/18

(52) U.S. Cl. CPC G06F 1/206; G06F 1/181

(57) ABSTRACT

Systems and methods for managing thermal and acoustic characteristics of an Information Handling System (IHS) based on the use of external peripheral devices are described. In an embodiment, an IHS may include a processor and a memory coupled to the processor, the memory having program instructions stored thereon that, upon execution, cause the IHS to detect that a peripheral device is coupled to the IHS, and, in response to the detection, modify a thermal or acoustic characteristic of the IHS.

### FIELD

This disclosure relates generally to Information Handling Systems (IHSs), and, more specifically, to systems and methods for managing thermal and acoustic characteristics of an IHS based on the use of external peripheral devices.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

Systems and methods for managing thermal and acoustic characteristics of an Information Handling System (IHS) based on the use of external peripheral devices are described. In an illustrative, non-limiting embodiment, an IHS may include a processor and a memory coupled to the processor, the memory having program instructions stored thereon that, upon execution, cause the IHS to detect that a peripheral device is coupled to the IHS, and, in response to the detection, modify a thermal or acoustic characteristic of the IHS.

In some cases, the peripheral device may include an external keyboard and, to modify the thermal or acoustic characteristic of the IHS, the program instructions, upon execution, cause the IHS to increase a temperature sensor threshold value. The program instructions, upon execution, may cause the IHS to: receive a user input via a built-in keyboard or trackpad; and in response to the user input, decrease the temperature sensor threshold value.

To modify the thermal or acoustic characteristic of the IHS, the program instructions, upon execution, may cause the IHS to increase a clock speed of the processor. Additionally, or alternatively, to modify the thermal or acoustic characteristic of the IHS, the program instructions, upon execution, may cause the IHS to increase a speed of a cooling fan.

In other cases, the peripheral device may include an external headset, and to modify the thermal or acoustic characteristic of the IHS, the program instructions, upon execution, may cause the IHS to increase a fan speed limit of a cooling fan. The program instructions, upon execution, may also cause the IHS to: determine that the external headset is turned off or disconnected and, in response to the determination, decrease the fan speed limit. The program instructions, upon execution, may also cause the IHS to: determine that at least one of: a noise cancellation feature is turned on, or a microphone is muted; and in response to the determination, increase the fan speed limit. The program instructions, upon execution, may further cause the IHS to determine that at least one of: the noise cancellation feature is turned off or the microphone is unmuted and, in response to the determination, decrease the fan speed limit.

In yet other cases, the peripheral device may include an external headset, and to modify the thermal or acoustic characteristic of the IHS, the program instructions, upon execution, may cause the IHS to increase a fan speed ramp of a cooling fan. The program instructions, upon execution, may cause the IHS to: determine that the external headset is turned off or disconnected and, in response to the determination, decrease the fan speed ramp.

The program instructions, upon execution, may cause the IHS to determine that at least one of: a noise cancellation feature is turned on, or a microphone is muted and, in response to the determination, increase the fan speed ramp. Additionally, or alternatively, the program instructions, upon execution, may cause the IHS to: determine that at least one of: the noise cancellation feature is turned off or the microphone is unmuted and, in response to the determination, decrease the fan speed ramp. Additionally, or alternatively, the program instructions, upon execution, may cause the IHS to determine that the IHS rests upon a table or desk and, in response to the determination, increase at least one of: a temperature sensor threshold value, a fan speed limit, or a fan speed ramp. The increase due to the determination may be smaller than the increase due to the detection. Additionally, or alternatively, the program instructions, upon execution, may cause the IHS to: determine that the IHS does not rest upon a table or desk and, in response to the determination, decrease at least one of: a temperature sensor threshold value, a fan speed limit, or a fan speed ramp.

In another illustrative non-limiting embodiment, a method may include detecting a peripheral device and modifying, in response to the detection, at least one of: a skin temperature sensor threshold value, a fan speed limit, or a fan speed ramp of an IHS. The method may also include modifying the skin temperature sensor threshold value, fan speed limit, or fan speed ramp of the IHS, at least in part, in response to a determination that a feature of the peripheral device is enabled.

In yet another illustrative, non-limiting embodiment, a memory storage device may have program instructions stored thereon that, upon execution by an IHS, cause the IHS to detect an external device coupled to the IHS and modify, in response to the detection, at least one of: a skin temperature sensor threshold value, a fan speed limit, or a fan speed ramp. For example, the external device may include a keyboard or a headset.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 depicts a block diagram of examples of components of an Information Handling System (IHS), according to some embodiments.

FIG. 2 depicts a block diagram of an example of a system for managing thermal and acoustic characteristics of an IHS based on the use of external peripheral devices, according to some embodiments.

FIGS. 3A and 3B depict a flowchart of an example of a method for managing thermal and acoustic characteristics of an IHS based on the use of external peripheral devices, according to some embodiments.

FIG. 4 depicts a sequence diagram of an example of a method for managing thermal and acoustic characteristics of an IHS based on the use of external peripheral devices, according to some embodiments.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

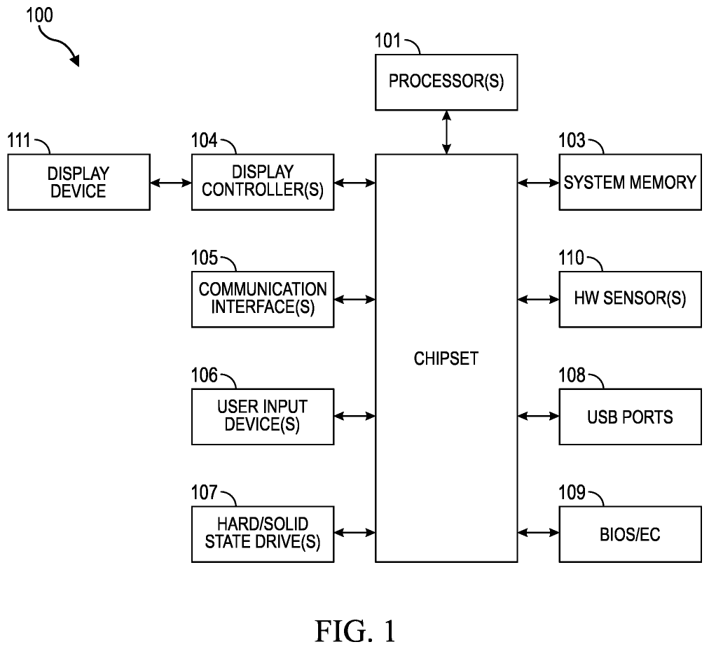

An IHS may include random access memory (RAM), one or more processing resources such as a central processing unit (CPU) or hardware or software control logic, ROM, and/or other types of nonvolatile memory. Additional components of an IHS may include one or more disk drives, one or more network ports for communicating with external devices as well as various input and output (I/O) devices, such as a keyboard, a mouse, touchscreen and/or a video display. An IHS may also include one or more buses operable to transmit communications between the various hardware components. A more detailed example of an IHS is described with respect to FIG. 1. It should be appreciated that although certain embodiments are discussed in the context of a personal computing device, other embodiments may utilize other types of IHSs.

In many situations, the performance of an IHS can be affected by thermal concerns. For example, when an IHS executes a high-performance application (e.g., a video game, a collaboration or video/audio conferencing application, a video/audio editing application, etc.), the external surface of the IHS's chassis or housing may reach temperatures that are unsafe for the user physically operating the IHS (e.g., resting their hands on it).

As a result, IHSs are typically configured to restrict their performance (e.g., by reducing their processors' speeds) when subject to certain temperature conditions. That is, in order to avoid producing high surface temperatures, certain types of applications are often executed at a lowered performance level. On a laptop, for example, gaming performance is often curbed due to high surface or skin temperatures, particularly near the “C cover” (upper or keyboard/trackpad) and “D cover” (underside or bottom) areas.

To illustrate, consider a first hypothetical scenario where a first user is playing a game with an external keyboard and mouse. During gameplay, if the IHS experiences thermal threshold triggers and lowers CPU's power level settings to limit skin impact, it also reduces the quality of the first user's experience. Now consider a second hypothetical where a second user is playing a video game with a headset and active noise cancelation enabled. During the gameplay, the CPU temperature rises, and as a result, the cooling fan turns on. After the fan achieves its maximum rate or speed, if the CPU temperature is still above threshold targets, the CPU is again throttled to reduce acoustic and/or thermal levels, which in turn also reduces the quality of the second user's experience during the game.

In both hypotheticals, users may observe reduced gaming performance and poor acoustic experience as their IHSs reach their thermal limits. Conventionally, IHSs make these performance throttling adjustments without regard for whether its user is operating an external keyboard or wearing a headset with active noise cancelation enabled, for example.

To address these, and other concerns, systems and methods described herein configure an IHS to manage its performance based on the use of external peripheral devices. In some implementations, these systems and methods may detect the use of an external keyboard, a closed lid, and/or an on-table posture to allow IHS surfaces to reach higher temperatures than when the external keyboard is absent, the lid is open, and/or the IHS is not resting on a table. In other implementations, these systems and methods may detect the use of an external headset (e.g., with noise cancellation on and/or a microphone muted) to allow a cooling fan within the IHS to run at higher speeds, and produce higher noise, than when the external headset is absent.

FIG. 1 is a block diagram of components of IHS 100, according to some embodiments. As depicted, IHS 100 includes processor 101. In various embodiments, IHS 100 may be a single-processor system, or a multi-processor system including two or more processors. Processor 101 may include any processor capable of executing program instructions, such as a PENTIUM series processor, or any general-purpose or embedded processors implementing any of a variety of Instruction Set Architectures (ISAs), such as an x86 ISA or a Reduced Instruction Set Computer (RISC) ISA (e.g., POWERPC, ARM, SPARC, MIPS, etc.).

IHS 100 includes chipset 102 coupled to processor 101. Chipset 102 may provide processor 101 with access to several resources. In some cases, chipset 102 may utilize a QuickPath Interconnect (QPI) bus to communicate with processor 101. Chipset 102 may also be coupled to communication interface(s) 105 to enable communications between IHS 100 and various wired and/or wireless networks, such as Ethernet, WiFi, BT, cellular or mobile networks (e.g., CDMA, TDMA, LTE, etc.), satellite networks, or the like. In some cases, communication interface(s) 105 may be used to communicate with peripheral devices (e.g., BT speakers, microphones, headsets, etc.). Moreover, communication interface(s) 105 may be coupled to chipset 102 via a PCIe bus.

Chipset 102 may be coupled to display controller(s) 104, which may include one or more or graphics processor(s) (GPUs) on a graphics bus, such as an Accelerated Graphics Port (AGP) or Peripheral Component Interconnect Express (PCIe) bus. As shown, display controller(s) 104 provide video or display signals to display device 111. In other implementations, any number of display controllers or display devices may be used.

Display device 111 may include Liquid Crystal Display (LCD), Light Emitting Diode (LED), organic LED (OLED), or other thin film display technologies. Display device 111 may include a plurality of pixels arranged in a matrix, configured to display visual information, such as text, two-dimensional images, video, three-dimensional images, etc. In some cases, display device 111 may be provided as a single continuous display, rather than two discrete displays.

Chipset 102 may provide processor 101 and/or display controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a solid-state drive (SSD) or the like. Memory 103 may store program instructions that, upon execution by processor 101, enable a collaboration mode for a touchpad coupled or integrated into IHS 100.

Chipset 102 may also provide access to one or more hard disk and/or solid-state drives 107. In certain embodiments, chipset 102 may also provide access to one or more optical drives or other removable-media drives. In certain embodiments, chipset 102 may also provide access to one or more USB ports 108, to which one or more peripheral devices may be coupled (e.g., internal or external webcams, microphones, speakers, etc.).

Chipset 102 may further provide access to one or more user input devices 106, for example, using a super I/O controller or the like. Examples of user input devices 106 include, but are not limited to, a keyboard, mouse, touchpad, stylus or active pen, totem, etc. Each of user input devices 106 may include a respective controller (e.g., a touchpad may have its own touchpad controller) that interfaces with chipset 102 through a wired or wireless connection (e.g., via communication interfaces(s) 105).

In certain embodiments, chipset 102 may also provide an interface for communications with one or more hardware (HW) sensors 110. Sensors 110 may be disposed on or within the chassis of IHS 100, and may include, but are not limited to: electric, magnetic, radio, optical, infrared, thermal, force, pressure, acoustic, ultrasonic, proximity, position, deformation, bending, direction, movement, velocity, rotation, and/or acceleration sensor(s).

Upon booting of IHS 100, processor(s) 101 may utilize Basic Input/Output System (BIOS) instructions of BIOS/Embedded Controller (EC) 109 to initialize and test hardware components coupled to IHS 100 and to load an OS for use by IHS 100. BIOS 109 provides an abstraction layer that allows the OS to interface with certain hardware components that are utilized by IHS 100. Via the hardware abstraction layer provided by BIOS 109, software stored in system memory 103 and executed by processor 101 can interface with certain I/O devices that are coupled to IHS 100. The Unified Extensible Firmware Interface (UEFI) was designed as a successor to BIOS. As a result, many modern IHSs utilize UEFI in addition to or instead of a BIOS. As used herein, BIOS 109 is intended to also encompass a UEFI component.

EC 109 may be installed as a Trusted Execution Environment (TEE) component to the motherboard of IHS 100. EC 109 may implement operations for interfacing with a power adapter in managing power for IHS 100. Such operations may be utilized to determine the power status of IHS 100, such as whether IHS 100 is operating from battery power or is plugged into an AC power source. Firmware instructions utilized by EC 109 may be used to provide various core operations of IHS 100, such as power management and management of certain modes of IHS 100 (e.g., turbo modes, maximum operating clock frequencies of certain components, etc.).

In some implementations, a low-power mode of operation may include the S0 low-power idle model, also known as Modern Standby or Connected Standby, which provides an instant on/off user experience and maintains a network connection for certain processes while consuming very little power. These power modes may be entered, for example, when IHS 100 transitions into standby (e.g., “sleep,” etc.).

EC 109 may also implement operations for detecting certain changes to the physical configuration or posture of IHS 100 and managing the modes of a touchpad or other user input device 106 in different configurations of IHS 100. For instance, where IHS 100 as a 2-in-1 laptop/tablet form factor, EC 109 may receive inputs from a lid position or hinge angle sensor 110, and it may use those inputs to determine: whether the two sides of IHS 100 have been latched together to a closed position or a tablet position, the magnitude of a hinge or lid angle, etc.

EC 109 may be further configured to calculate hashes or signatures that uniquely identify individual components of IHS 100. In such scenarios, EC 109 may calculate a hash value based on the configuration of a hardware and/or software component coupled to IHS 100. For instance, EC 109 may calculate a hash value based on all firmware and other code or settings stored in an onboard memory of a hardware component. Such hash values may be calculated as part of a trusted process of manufacturing IHS 100 and may be maintained in secure storage as a reference signature. EC 109 may later recalculate the hash value for a component may compare it against the reference hash value to determine if any modifications have been made to the component, thus indicating that the component has been compromised. In this manner, EC 109 may validate the integrity of hardware and software components installed on IHS 100.

In other embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components. For example, all or a portion of the operations executed by the illustrated components may instead be provided by components integrated into processor(s) 101 as systems-on-a-chip (SoC). As such, in certain embodiments, IHS 100 may be implemented as different classes of computing devices including, but not limited to: servers, workstations, desktops, laptops, appliances, video game consoles, tablets, smartphones, etc.

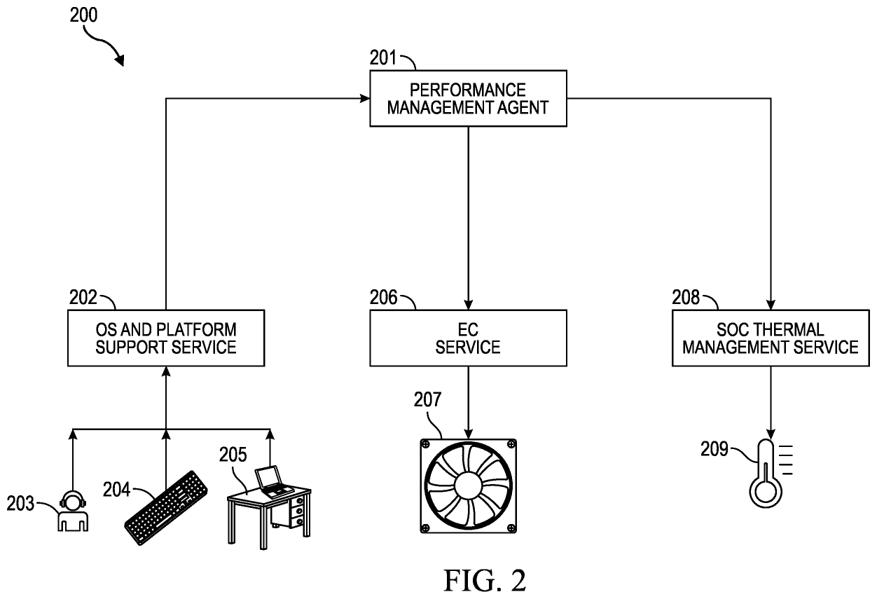

FIG. 2 depicts a block diagram of an example of system 200 for managing thermal and acoustic characteristics of an IHS based on the use of external peripheral devices. In some embodiments, components of system 200 may be instantiated, at least in part, through the execution by a processor (e.g., processor(s) 101) of program instructions stored in a memory device (e.g., system memory 103) of one or more IHSs (e.g., IHS 100).

As shown, system 200 includes performance management agent 201 coupled to OS and platform support service 202, EC service 206, and SoC thermal management service 208. OS and platform support service 202 is configured to receive inputs from first peripheral device 203 (e.g., an audio headset), second peripheral device 204 (e.g., an external keyboard), and from one or more sensor(s) 205 (e.g., an accelerometer). Moreover, EC service 206 is configured to communicate with IHS cooling fan 207 and SoC thermal management service 208 is configured to communicate with one or more temperature sensors 209 (e.g., a skin temperature sensor).

In operation, performance management agent 201 may be configured to detect contextual usage indicators, predict current and near future needs, and/or modify IHS thermal, cooling, and/or acoustic settings to deliver increased or optimized performance.

Particularly, OS and platform support service 202 may be configured to detect an external keyboard (EKB) and/or headset (EHS), as well as whether one or more features of these devices are enabled (e.g., mic muting, noise cancelling for ENC). OS and platform support service 202 may also be configured to detect, for example, whether IHS 100 is on a table (ONT) or on a user's lap. Performance management agent 201 takes its inputs from OS and platform support service 202, computes new thermal threshold/acoustic ramps and limits, and sends appropriate notifications to EC service 206 and/or SoC thermal management service 208 to update settings or policies that increase or reduce: a thermal threshold value, a fan speed limit, a fan speed ramp, etc.

As used herein, the term “fan speed ramp” refers to a table or formula that determines the manner in which a cooling fan's rotational speeds can change (i.e., by what increments) in response to temperature changes (e.g., as detected by a skin temperature sensor, etc.). Meanwhile, the term “fan speed limit” refers to an absolute maximum or minimum speed of rotation of a cooling fan (e.g., in RPMs). In various implementations, a temperature, cooling, or acoustic policy may dictate at least one of a fan speed ramp or limit.

In some embodiments, decisions reached by performance management agent 201 based upon input data from OS and platform support service 202 may include, but are not limited to: applying a first thermal policy to relax skin temperatures (i.e., increase the skin temperature tolerance or threshold value) when external keyboard is detected (SKN_KBD_Y) by an amount, applying a second thermal policy to relax skin temperatures when the IHS is determined to be on a table or desk (SKN_ONT_Y) by another amount, restoring a default thermal policy (SKN_N), increasing a fan speed ramp rate with headphones by a first amount (FNR1_Y), increasing a fan speed ramp limit with headphones (FNS1_Y) by another first amount, increasing a fan speed ramp rate when noise canceling headphones are detected and/or the feature is turned on (FNR2_Y) by a second amount greater than the first amount, increasing a fan speed ramp limit when noise canceling headphones are detected and/or the feature is turned on (FNS2_Y) by another second amount greater than the other first amount, restoring a fan speed ramp rate (FNR_N), restoring a fan speed ramp limit (FNS_N), etc.

Performance management agent 201 may also use Machine Learning or Artificial Intelligence (ML/AI) models to determine, based on other inputs and/or a history of usage, how long a video game title or high-performance application is predicted to be executed, so that the higher skin temperature or higher acoustic noise adjustment may be temporarily set to match that time or duration (e.g., the duration of a gaming session or video conference call). Additionally, or alternatively, performance management agent 201 may receive an indication from OS and platform support service 202 of whether a headset's microphone is muted to make additional fan speed adjustments (e.g., when mic is unmuted, reduce fan speed/performance; when mic is muted, increase fan speed/performance).

In various embodiments, in order to reach a thermal, cooling, and/or acoustic determination, performance management agent 201 may execute ML/AI model or workloads including, but not limited to: regression workloads (e.g., Ordinary Least Squares Regression (OLSR), Linear Regression, Logistic Regression, Stepwise Regression, Multivariate Adaptive Regression Splines (MARS), Locally Estimated Scatterplot Smoothing (LOESS), etc.), instance-based workloads (e.g., k-Nearest Neighbor (kNN), Learning Vector Quantization (LVQ), Self-Organizing Map (SOM), Locally Weighted Learning (LWL), Support Vector Machines (SVM), etc.), regularization workloads (e.g., Ridge Regression, Least Absolute Shrinkage and Selection Operator (LASSO), Elastic Net, Least-Angle Regression (LARS), etc.), decision tree workloads (e.g., Classification and Regression Tree (CART), Iterative Dichotomizer 3 (ID3), C4.5 and C5.0, Chi-squared Automatic Interaction Detection (CHAID), Decision Stump, M5, Conditional Decision Trees, etc.), Bayesian workloads (e.g., Naive Bayes, Gaussian Naive Bayes, Multinomial Naive Bayes, Averaged One-Dependence Estimators (AODE), Bayesian Belief Network (BBN), Bayesian Network (BN), etc.), clustering workloads (e.g., k-Means, k-Medians, Expectation Maximization (EM), Hierarchical Clustering, Association Rule Learning Algorithms, etc.), association rule learning workloads (e.g., Apriori algorithm, Eclat algorithm, etc.), artificial neural network workloads (e.g., Perceptron, Multilayer Perceptrons (MLP), Back-Propagation, Stochastic Gradient Descent, Hopfield Network Radial Basis Function Network (RBFN), etc.), deep learning workloads (e.g., Convolutional Neural Network (CNN), Recurrent Neural Networks (RNNs), Long Short-Term Memory Networks (LSTMs), Stacked Auto-Encoders, Deep Boltzmann Machine (DBM), Deep Belief Networks (DBN), etc.), dimensionality reduction workloads (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA), etc.), ensemble workloads (e.g., Boosting, Bootstrapped Aggregation (Bagging), AdaBoost, Weighted Average (Blending), Stacked Generalization (Stacking), Gradient Boosting Machines (GBM), Gradient Boosted Regression Trees (GBRT), Random Forest, etc.), etc.

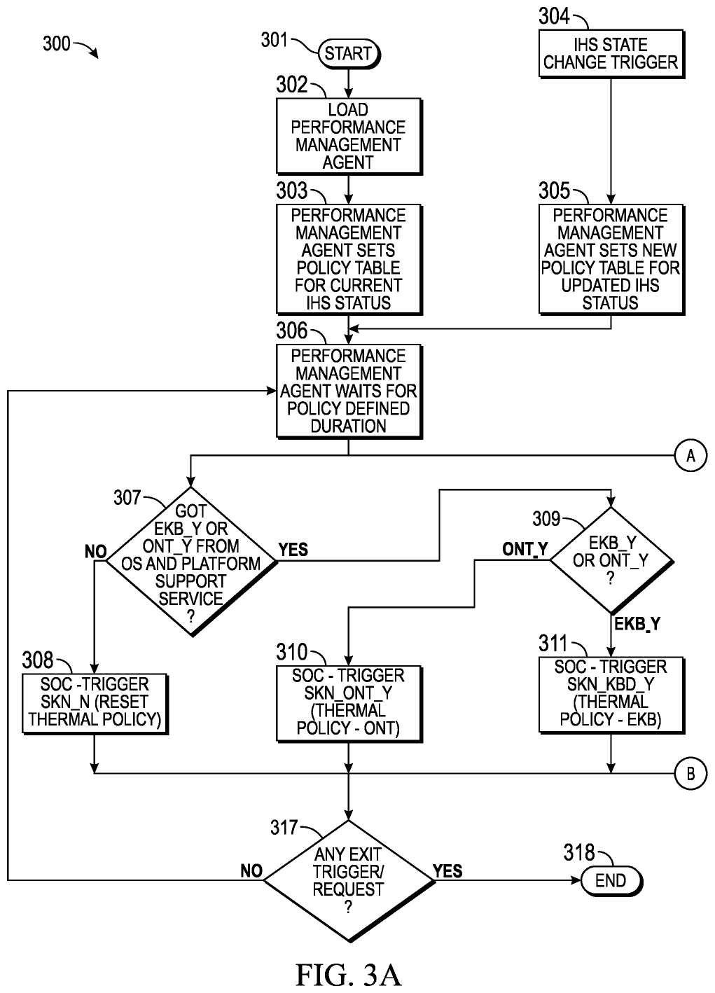

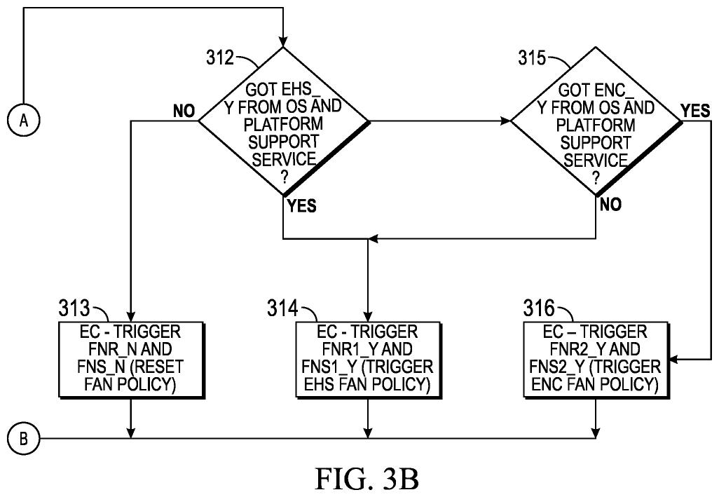

FIGS. 3A and 3B depict flowchart 300 of an example of a method for managing thermal and acoustic characteristics of an IHS based on the use of external peripheral devices. In various embodiments, operations of flowchart 300 may be performed, at least in part, by components 200 shown in FIG. 2.

In flowchart 300, the following legend is used: External Keyboard: EKB_Y—Detected, EKB_N—Not Detected; Wired/Wireless Headset: EHS_Y—Detected, EHS_N—Not Detected; Noise Cancellation: ENC_Y—Detected, ENC_N—Not Detected; External Keyboard Thermal Policy: SKN_KBD_Y—Relax Skin Temp, SKN_KBD_N—Reset Skin Temp; On-Table Thermal Policy: SKN_ONT_Y—Relax Skin Temp, SKN_ONT_N—Reset Skin Temp; Fan Speed Ramp: FNRx_Y—Increase Ramp Rate, FNR_N—Reset Ramp; and Fan Speed Limit: FNSx_Y—Increase Fan Speed Limit, FNSx_N—Reset Speed.

Method 300 begins at 301. At 302, IHS 100 instantiates, loads, or executes performance management agent 201. At 303, performance management agent 201 sets thermal and/or acoustic/fan policy table(s) for the IHS's status. Additionally, or alternatively, at 304, a change in IHS state is triggered and, at 305, performance management agent 201 sets new policy table(s) for an updated IHS status.

At 306, performance management agent 201 waits for a duration defined in the polic(ies). In some cases, the duration may include hysteresis to ensure IHS 100 is in a steady state (e.g., 5 minutes of external keyboard usage).

At 307, OS and platform support service 202 detects if an external keyboard is attached to IHS 100. If not, at 308 performance management agent 201 instructs SoC thermal management service 208 to reset its thermal policy and return a skin temperature threshold to a previous value before method 300 proceeds to 317.

If the currently active keyboard is identified as external, OS and platform support service 202 sends EKB_Y to performance management agent 201 at 309, otherwise it sends EKB_N. Additionally, or alternatively, at 307, OS and platform support service 202 detects if IHS 100 is on-lap or on-table. If IHS 100 is on-table, OS and platform support service 202 sends ONT_Y to platform support service 202 at 309, otherwise it sends ONT_N.

At 310, if performance management agent 201 receives EKB_Y, it instructs SoC thermal management service 208 to implement a first thermal policy SKN_KBD_Y (e.g., increase a skin temperature threshold value relaxation or headroom by 4° C.). At 311, if performance management agent 201 receives ONT_Y, it instructs SoC thermal management service 208 to implement a second thermal policy SKN_ONT_Y (e.g., increase a skin temperature threshold value relaxation or headroom by 2° C.). In some cases, if both EKB_Y and ONT_Y are received, performance management agent 201 may implement the most aggressive policy between the two (e.g., the SKN_KBD_Y policy), or it may apply a third thermal policy.

At 312, OS and platform support service 202 detects if a headset is attached to IHS 100. If not, at 313 performance management agent 201 instructs EC service 206 to reset its fan speed rate policy (FNR_N) policy and fan speed limit policy (FNS_N) and return previous cooling fan speed values, before method 300 proceeds to 317. If at 312 OS and platform support service 202 detects a headset attached to IHS 100, control passes to 314.

At 315, OS and platform support service 202 detects if a noise canceling or microphone muting feature is activated or enabled. If so, control I passes to 316. Otherwise, control passes to 314.

At 314, performance management agent 201 instructs EC service 206 to implement first fan speed rate and/or limit policies FNR1_Y and FNS1_Y, which are greater (i.e., provide more cooling) than reset or default policies. Conversely, at 316, performance management agent 201 instructs EC service 206 to implement second fan speed rate (e.g., %) and/or limit (e.g., in RPMs) policies FNR2_Y and FNS2_Y. In some cases, the second fan speed rate and/or limit policies may be greater than the first fan speed rate and/or limit policies.

For sake of illustration, Table I below shows specific examples of performance management agent 201's hysteresis, skin temperature relaxation, fan ramp rate increase and fan speed limit values for AC and DC applications for four BIOS-based user-selectable thermal tables (USTTs): cool, quiet, optimal, and ultra performance:

TABLE I

| | AC vs. | USTT- | USTT- | USTT- | USTT- |
|---|---|---|---|---|---|
| Policy | DC | Cool | Quiet | Optimal | Ultra Perf |
| Hysteresis | AC | 2 | 4 | 2 | 1 |
| (min) | DC | 4 | 6 | 4 | 2 |
| Skin Temp | AC | 4/2 | 2/1 | 3/1.5 | 5/2.5 |
| Relaxation- | DC | 2/1 | 1/0.5 | 2/1 | 3/1.5 |
| KBD/ONT | | | | | |
| (deg.) | | | | | |
| Fan Ramp | AC | 10/15 | 2/4 | 8/12 | 10/15 |
| Rate Increase- | DC | 7/10 | 1/2 | 4/8 | 7/10 |
| FNR1/FNR2 | | | | | |
| (%) | | | | | |
| Fan Speed | AC | 5500/6500 | 1500/2500 | 4000/5000 | 5500/6500 |
| Limit- | DC | 3500/4500 | 800/1000 | 2500/3000 | 3500/4500 |
| FNS1/FNS2 | | | | | |
| (RPM) | | | | | |

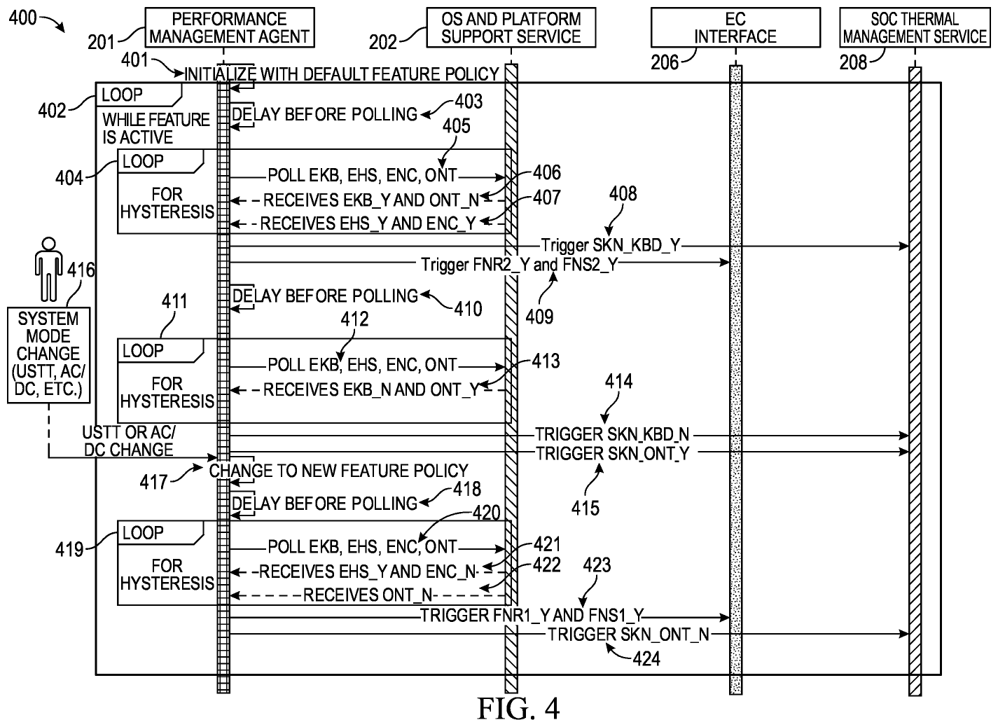

FIG. 4 depicts sequence diagram 400 of an example of a method for managing thermal and acoustic characteristics of an IHS based on the use of external peripheral devices. In various embodiments, operations of sequence diagram 400 may be performed, at least in part, by components 200 shown in FIG. 2 executing method 300 of FIG. 3.

At 401, performance management agent 201 initializes with an initial or default thermal, cooling, and/or acoustic IHS policy (blocks 302 and 303 in FIG. 3). Overall loop 402 operates while the policy is active. At 403, performance management agent 201 adds hysteresis to method 400 by delaying before polling (block 306 in FIG. 3).

At 405 within loop 404, performance management agent 201 polls EKB, EHS, ENC, and ONT values from OS and platform support service 202. At 406, performance management agent 201 receives EKB_Y and ONT_N from OS and platform support service 202 (block 307 in FIG. 3). At 407, performance management agent 201 receives EHS_Y and ENC_Y from OS and platform support service 202 (blocks 312 and 315 in FIG. 3).

In response, at 408, performance management agent 201 triggers SKN_KBD_Y with SoC management service 208 (block 311 in FIG. 3). At 409, performance management agent 201 triggers FNR2_Y and FNS2_Y with EC service 206 (block 316 in FIG. 3).

At 410, performance management agent 201 maintains hysteresis in method 400 by delaying before polling. At 412 within loop 411, performance management agent 201 polls EKB, EHS, ENC, and ONT from OS and platform support service 202. At 413, performance management agent 201 receives EKB_N and ONT_Y from OS and platform support service 202. In response, at 414, performance management agent 201 triggers SKN_KBD_N with SoC management service 208. At 415, performance management agent 201 triggers SKN_ONT_Y with SoC management service 208 (block 310 in FIG. 3).

At 417, method 400 receives a policy change from a user or administrator of IHS 100. At 417, performance management agent 201 changes the IHS's thermal, cooling, and/or acoustic policy to the newly selected one(s).

At 418, performance management agent 201 adds hysteresis to method 400 by delaying before polling. At 420 within loop 419, performance management agent 201 polls EKB, EHS, ENC, and ONT from OS and platform support service 202. At 422, performance management agent 201 receives EKH_Y and ENC_N from OS and platform support service 202. At 422, performance management agent 201 receives ONT_N from OS and platform support service 202.

In response at 423, performance management agent 201 triggers FNR1_Y and FNS1_Y with EC service 206 (block 314 in FIG. 3). At 424, performance management agent 201 triggers SKN_ONT_N with SoC management service 208.

In many implementations, systems and methods described herein may be incorporated into a wide range of electronic devices including, for example, computer systems or Information Technology (IT) products such as servers, desktops, laptops, memories, switches, routers, etc.; telecommunications hardware; consumer devices or appliances such as mobile phones, tablets, wearable devices, IoT devices, television sets, cameras, sound systems, etc.; scientific instrumentation; industrial robotics; medical or laboratory electronics such as imaging, diagnostic, or therapeutic equipment, etc.; transportation vehicles such as automobiles, buses, trucks, trains, watercraft, aircraft, etc.; military equipment, etc. More generally, these systems and methods may be incorporated into any device or system having one or more electronic parts or components.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS), comprising:
a processor; and
a memory coupled to the processor, the memory having program instructions stored thereon that, upon execution, cause the IHS to:
detect that a peripheral device is coupled to the IHS; and
in response to the detection, modify a thermal or acoustic characteristic of the IHS.

2. The IHS of claim 1, wherein the peripheral device comprises an external keyboard, and wherein to modify the thermal or acoustic characteristic of the IHS, the program instructions, upon execution, cause the IHS to increase a temperature sensor threshold value.

3. The IHS of claim 2, wherein the program instructions, upon execution, cause the IHS to:
receive a user input via a built-in keyboard or trackpad; and
in response to the user input, decrease the temperature sensor threshold value.

4. The IHS of claim 2, wherein to modify the thermal or acoustic characteristic of the IHS, the program instructions, upon execution, cause the IHS to increase a clock speed of the processor.

5. The IHS of claim 4, wherein to modify the thermal or acoustic characteristic of the IHS, the program instructions, upon execution, cause the IHS to increase a speed of a cooling fan.

6. The IHS of claim 1, wherein the peripheral device comprises an external headset, and wherein to modify the thermal or acoustic characteristic of the IHS, the program instructions, upon execution, cause the IHS to increase a fan speed limit of a cooling fan.

7. The IHS of claim 6, wherein the program instructions, upon execution, cause the IHS to:
determine that the external headset is turned off or disconnected; and
in response to the determination, decrease the fan speed limit.

8. The IHS of claim 7, wherein the program instructions, upon execution, cause the IHS to:
determine that at least one of: a noise cancellation feature is turned on, or a microphone is muted; and
in response to the determination, increase the fan speed limit.

9. The IHS of claim 8, wherein the program instructions, upon execution, cause the IHS to:
determine that at least one of: the noise cancellation feature is turned off or the microphone is unmuted; and
in response to the determination, decrease the fan speed limit.

10. The IHS of claim 1, wherein the peripheral device comprises an external headset, and wherein to modify the thermal or acoustic characteristic of the IHS, the program instructions, upon execution, cause the IHS to increase a fan speed ramp of a cooling fan.

11. The IHS of claim 10, wherein the program instructions, upon execution, cause the IHS to:
determine that the external headset is turned off or disconnected; and
in response to the determination, decrease the fan speed ramp.

12. The IHS of claim 10, wherein the program instructions, upon execution, cause the IHS to:
determine that at least one of: a noise cancellation feature is turned on, or a microphone is muted; and
in response to the determination, increase the fan speed ramp.

13. The IHS of claim 12, wherein the program instructions, upon execution, cause the IHS to:
determine that at least one of: the noise cancellation feature is turned off or the microphone is unmuted; and
in response to the determination, decrease the fan speed ramp.

14. The IHS of claim 1, wherein the program instructions, upon execution, cause the IHS to:
determine that the IHS rests upon a table or desk; and
in response to the determination, increase at least one of: a temperature sensor threshold value, a fan speed limit, or a fan speed ramp.

15. The IHS of claim 14, wherein the increase due to the determination is smaller than the increase due to the detection.

16. The IHS of claim 14, wherein the program instructions, upon execution, cause the IHS to:
determine that the IHS does not rest upon a table or desk; and
in response to the determination, decrease at least one of: a temperature sensor threshold value, a fan speed limit, or a fan speed ramp.

17. A method, comprising:
detecting a peripheral device; and
modifying, in response to the detection, at least one of: a skin temperature sensor threshold value, a fan speed limit, or a fan speed ramp of an Information Handling System (IHS).

18. The method of claim 17, further comprising modifying the skin temperature sensor threshold value, fan speed limit, or fan speed ramp of the IHS, at least in part, in response to a determination that a feature of the peripheral device is enabled.

19. A memory storage device having program instructions stored thereon that, upon execution by an Information Handling System (IHS), cause the IHS to:
detect an external device coupled to the IHS; and
modify, in response to the detection, at least one of: a skin temperature sensor threshold value, a fan speed limit, or a fan speed ramp.

20. The memory storage device of claim 19, wherein the external device comprises a keyboard or a headset.
